(19) United States
(12) Patent Application Publication
(10) Pub. No.: US 2013/0306883 A1
(43) Pub. Date: Nov. 21, 2013

(54) ACCELERATED UV IRRADIATION TEST ON COATINGS

(71) Applicant: Lucy G. Lim, Riverstone (AU)

(72) Inventor: Lucy G. Lim, Riverstone (AU)

(73) Assignee: E.I.Dupont de Nemours and Company, Wilmington, DE (US)

(21) Appl. No.: 13/982,497

(22) PCT Filed: Feb. 1, 2012
(86) PCT No.: PCT/US12/23525

§ 371 Date: Jul. 30, 2013

Related U.S. Application Data
(60) Provisional application No. 61/438,301, filed on Feb. 1, 2011.

(51) Int. Cl. G01N 31/00

(52) U.S. Cl. CPC G01N 31/00
USPC 250/492.1

(57) ABSTRACT

The present disclosure is directed to a process for testing UV irradiation on a target coating. The process provides high UV irradiation having one or more UV irradiation wavelengths in a range of from 250 nm to 450 nm and a peak irradiation power in a range of from 400 W/m² to 20,000 W/m². The process provides accelerated testing for coatings that can be completed within a few minutes to a few hours instead of a few thousand hours to many months by conventional testing methods. The process can test one or more target coatings and control coatings under one or more selected testing conditions.

This application claims priority from U.S. Provisional Application Ser. No. 61/438,301 (filed Feb. 1, 2011), the disclosure which is incorporated by reference herein for all purposes as if fully set forth.

### FIELD OF INVENTION

The present invention is directed to a process for accelerated UV irradiation test on one or more coatings. The present invention is further directed to a system for performing the accelerated UV irradiation test.

### BACKGROUND OF INVENTION

Typical accelerated ultraviolet (UV) irradiation tests on coatings can take in a range of from 1000 to 3000 hours or an average of 2 to 4 months to complete. Commonly used accelerated tests process can involve the use of Xenon Arc or QUV lamps to provide UV irradiations that can cause the photo-degradation to coatings under test similar to those exposed to outdoor conditions. The tests are typically done in an exposure chamber wherein one or more UV irradiation sources, such as one or more UV lamps, are installed and regulated to provide controlled UV irradiation.

### STATEMENT OF INVENTION

This invention is directed to a process for testing UV irradiation on at least one target coating, said process comprising the steps of:
a. providing the target coating;
b. irradiating said target coating with an UV irradiation for a preset irradiation time period to produce an irradiated target coating, said UV irradiation having one or more UV irradiation wavelengths in a range of from 250 nm to 450 nm and an irradiation power in a range of from 400 W/m² to 20,000 W/m² measured at said target coating; and
c. obtaining irradiated target coating data of said irradiated target coating, wherein said irradiated target coating data comprise data selected from color data, gloss data, adhesion data, hardness data, chipping data, corrosion data, or a combination thereof.

This invention is also directed to a process for testing UV irradiation on at least one target coating, said process comprising the steps of:
a) providing the target coating having at least a first section and a second section;
a1) blocking the second section of said target coating preventing said second section from being irradiated to produce an un-irradiated target coating;
b) irradiating said first section of said target coating with an UV irradiation for a preset irradiation time period to produce an irradiated target coating, said UV irradiation having one or more UV irradiation wavelengths in a range of from 250 nm to 450 nm and an irradiation power in a range of from 400 W/m² to 20,000 W/m² measured at said, target coating; and
c1) obtaining target coating data from said irradiated target coating and said un-irradiated target coating, wherein said target coating data comprise data selected from color data, gloss data, adhesion data, hardness data, chipping data, corrosion data, or a combination thereof.

This invention is further directed to system for testing UV irradiation on a target coating, said system comprising:
i) a testing chamber; and
ii) an UV irradiation source that is capable of providing an UV irradiation having one or more UV irradiation wavelengths in a range of from 250 nm to 450 nm and an irradiation power in a range of from 400 W/m² to 20,000 W/m², said UV irradiation source is configured to provide said irradiation within said testing chamber;

wherein said testing chamber comprises one or more testing control devices for providing testing conditions within said testing chamber, said testing conditions are selected from a preset humidity level, a preset temperature range, a predetermined salt type or combination, a preset salt level a preset acid level, a preset alkaline level or a combination thereof.

### BRIEF DESCRIPTION OF DRAWING

FIG. 1 shows examples of representative configurations of irradiation testing. (A) A target costing (2) on a substrate (3) is irradiated by the UV irradiation (1) to produce an irradiated target coating (2a). (B) A target coating and a control coating are on separate substrates and are irradiated by the UV irradiation. (C) A target coating and a control coating are on the same substrate and are irradiated by the UV irradiation. (D) A section of the target coating is blocked by an irradiation blocker to produce an un-irradiated target coating.

FIG. 2 shows examples of representative configurations of a system for testing UV irradiation on a coating. (A) A system comprising an irradiation chamber and a conveyer belt. (B) A system comprising an irradiation chamber without a conveyer belt.

FIG. 3 shows examples of representative configurations of an irradiation blocker. (A) An irradiation blocker having a target coating positioned thereon. (B) An irradiation blocker having a target coating and a control coating positioned thereon.

FIG. 4 shows an example of a configuration of an irradiation blocker having multiple coatings positioned thereon.

FIG. 5 shows an example of a configuration of the system with an irradiation chamber having an irradiation blocker and one or more coatings positioned therein.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also he provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

This disclosure is directed to a process for testing UV irradiation on at least one target coating. The process can comprise the steps of:

a) providing the target coating;

b) irradiating said target coating with an UV irradiation for a preset irradiation time period to produce an irradiated target coating, said UV irradiation having one or more UV irradiation wavelengths in a range of from 250 nm to 450 nm and an irradiation power in a range of from 400 Watt/m² to 20,000 Watt/m² (herein referred to as W/m²) measured at said target coating; and

c) obtaining irradiated target coating data of said irradiated target coating, wherein said irradiated target coating data comprise data selected from color data, gloss data, adhesion data, hardness data, chipping data, corrosion data, or a combination thereof.

The process can further comprise the steps of:

d) providing at least one control coating; and

e) irradiating said control coating with said UV irradiation to produce an irradiated control coating; and

f) obtaining irradiated control coating data from said irradiated control coating, wherein said irradiated control coating data comprise data selected from color data, gloss data, adhesion data, hardness data, chipping data, corrosion data, or a combination thereof.

The UV irradiation can have a peak UV irradiation wavelength in a range of from 250 nm to 450 nm. The UV irradiation can have a peak UV irradiation wavelength at 313 nm in one example, at 315 nm in another example, at 340 nm in yet another example, and at 368 nm in yet another example.

The irradiation power can be in a range of from 400 W/m² to 20,000 W/m² measured at the coating to be tested, for example the aforementioned target coating or control coating. The irradiation power can be in a range of from 400 W/m² to 20,000 W/m² in one example, from 500 W/m² to 20,000 W/m² in another example, from 600 W/m² to 20,000 W/m² in yet another example, from 800 W/m² to 20,000 W/m² in yet another example, from 1,000 W/m² to 20,000 W/m² in yet another example, from 1,500 W/m² to 20,000 W/m² in yet another example, from 2,000 W/m² to 20,000 W/m² in yet another example, from 2,500 W/m² to 20,000 W/m² in yet another example, from 3,000 W/m² to 20,000 W/m² in yet another example, and from 4,000 W/m² to 20,000 W/m² in yet another example.

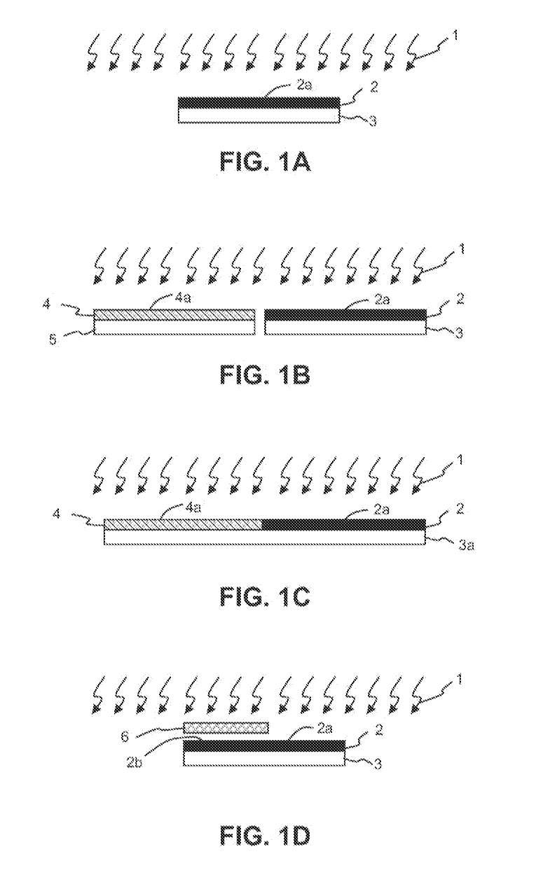

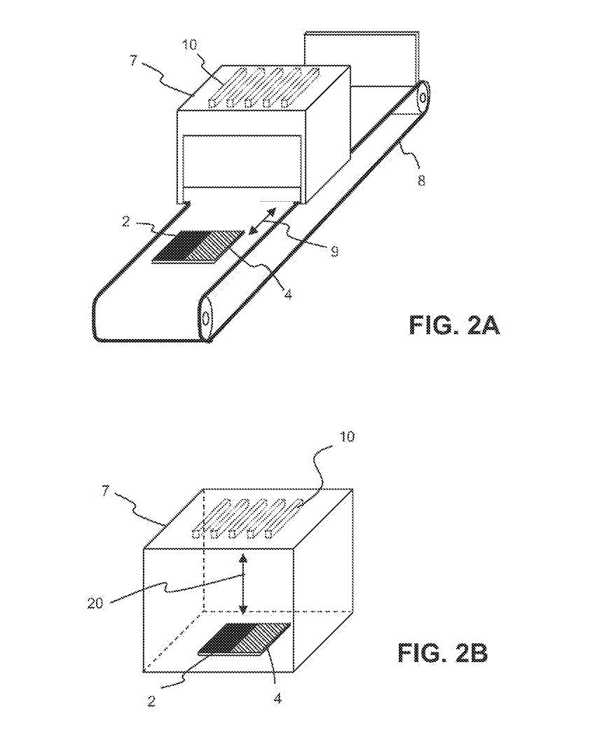

The UV irradiation (1) (FIG. 1A-1D) can be produced from a UV source such as a mercury UV lamp, a UV light-emitting diode (LED), or any other UV source that can provide the desired irradiation power at the target coating. A UV power measuring device, such as a UV POWER PUCK® FLASH, available from The EIT instrument, Sterling, Va. 20164, USA, under respective registered trademark, can be suitable to measure UV irradiation power. A power control device can he used to adjust or control the UV irradiation power. The irradiation power measured at the coating to be tested, such as the target coating or the control coating, can be adjusted by adjusting the distance between the UV source (10) and the coatings as indicated by the arrow (20) (FIG. 2). UV reflection assembly such configurations of reflection mirrors, power of the UV source such as the power of the UV lamp or UV LED, or a combination thereof.

Different UV source can also produce UV irradiations at same or different one or more peak wavelengths. In one example, an Arc UV source can have a peak wavelength at about 315 nm or 365 nm. In another example, an LED UV source can have a peak wavelength at about 365 nm.

The target coating (2) can be formed from a target coating composition over the substrate (3). The target coating composition can be a solvent borne or a waterborne coating composition. The target coating can be cured with one or more curing processes or curing mechanisms. Typical curing process can include curing temperatures, for example, at ambient temperatures, such as temperatures in a range of from 15° C. to 50° C., or at elevated temperatures, such as temperatures in a range of from 50° C. to 350° C.; curing time, such as from a few minutes to hours or days; or a combination thereof. The curing mechanisms can include chemical curing of coating compositions having crosslinkable and crosslinking functional groups, irradiation curing of coating compositions having irradiation curable functional groups, or drying of lacquer coating compositions. The term “lacquer” or “lacquer coating composition” refers a coating composition that is capable of drying by solvent evaporation to form a durable coating on a substrate.

Typical crosslinkable and crosslinking functional groups can include hydroxyl, thiol, isocyanate, thioisocyanate, acid or polyacid, acetoacetoxy, carboxyl, primary amine, secondary amine, epoxy, anhydride, ketimine, aldimine, or a workable combination thereof. Some other functions groups such as orthoester, orthocarbonate, or cyclic amide that can generate hydroxyl or amine groups once the ring structure is opened can also be suitable as crosslinkable functional groups.

It would be clear to one of ordinary skill in the art that certain crosslinking functional groups crosslink with certain crosslinkable functional groups. Examples of paired combinations of crosslinkable and crosslinking functional groups can include: (1) ketimine functional groups crosslinking with acetoacetoxy, epoxy, or anhydride functional groups; (2) isocyanate, thioisocyanate and melamine functional groups each crosslinking with hydroxyl, thiol, primary and secondary amine, ketimine, or aldimine functional groups; (3) epoxy functional groups crosslinking with carboxyl, primary and secondary amine, ketimine, or anhydride functional groups; (4) amine functional groups crosslinking with acetoacetoxy functional groups; (5) polyacid functional groups crosslinking with epoxy or isocyanate functional groups; and (6) anhydride functional groups generally crosslinking with epoxy and ketimine functional groups.

The irradiation curable functional groups can include ethylenically unsaturated double bonds, such as acrylic or methacrylic double bonds. Sources of UV irradiation for curing can include natural sunlight or artificial UV radiation sources. Examples of UV irradiation for curing can include, but not limited to, UV-A radiation, which falls within the wavelength range of from 320 nanometers (nm) to 400 nm; UV-B radiation, which is radiation having a wavelength falling in the range of from 280 nm to 320 mm; UV-C radiation, which is radiation having a wavelength falling in the range of from 100 nm to 280 nm; and UV-V radiation, which is radiation having a wavelength falling in the range of from 400 nm to 800 nm.

A coating composition having crosslinkable and crosslinking functional groups and the irradiation curable functional groups can be cured by a combination of the chemical curing and the irradiation curing. Such coating compositions can be referred to as a dual cure coating composition.

The control coating (4) can be from a coating composition similar to the target coating with one or more variations. The control coating (4) can be over the different substrate (5) (FIG. 1B) or over the same substrate (3a) (FIG. 1C) as the target coating. Typically, the control coating can be cured in the same way as the target coating. The control coating can also be formed from the same or different coating compositions as the target coating, but cured differently, such as by different curing temperatures, or different curing time,

It is preferred that the target coating, and the control coating if present, is already cured. The target coating, and the control coating if present, can be cured by any of the aforementioned curing mechanism or a combination thereof that is suitable for curing the coating or coatings.

The target coating and the control coating that have been exposed to the UV irradiation can be referred to as an irradiated target coating (2a), and irradiated control coating (4a), respectively.

The process can further comprise the step of obtaining a pre target coating data of said target coating prior to said irradiation, wherein said pre target coating data comprises data selected from color data, gloss data, adhesion data, hardness data, chipping data, corrosion data, or a combination thereof.

The irradiated target coating data, the irradiated control coating data, and optionally, the pre target coating data can then be compared to determine how the target coating is responding to the UV irradiation.

The color data of the process can be selected from L,a,b color data, L*,a*,b* color data, L,C,h color data, XYZ color data, era combination thereof. The color data can be defined according to The international Commission on Illumination—also known as the CIE (the Commission Internationale de l'Eclairage) (CIE Central Bureau, Kegelgasse Vienna, Austria),

The preset irradiation time period can be in a range of from 1 minute to 120 minutes. The preset irradiation time period can be in a range of from 1 to 100 minutes in one example, in a range of from 1 to 50 minutes in another example, in a range of from 1 to 30 minutes in yet another example, in a range of from 1 to 15 minutes in further another example.

According to the process of this disclosure, an irradiation time period in a range of from 5 to 30 minutes can cause photo-degradation to coatings similar to that caused by over 1000 hours irradiation with commonly used Xenon Arc or QUV lamps, therefore significantly accelerating UV irradiation test on coatings.

In the process disclosed herein, the UV irradiation can be provided in combination with additional testing conditions selected from a preset humidity level, a preset temperature range, a predetermined salt type or combination, a preset sail level, a preset acid level, a preset alkaline level, or a combination thereof.

The process can also comprise the steps of:

a) providing the target coating having at least a first section and a second section;

a1) blocking the second section of said target coating preventing said second section from being irradiated to produce an un-irradiated target coating;

b) irradiating said first section of said target coating with an UV irradiation for a preset irradiation time period to produce an irradiated target coating, said UV irradiation having one or more UV irradiation wavelengths in a range of from 250 nm to 450 nm and an irradiation power in a range of from 400 W/m² to 20,000 W/m² measured at said target coating; and

c1) obtaining target coating data from said irradiated target coating and said un-irradiated target coating, wherein said target coating data comprise data selected from color data, gloss data, adhesion data, hardness data, chipping data, corrosion data, or a combination thereof.

The process can further comprise the steps of:

a2) providing at least one control coating having at least a first control section and a second control section;

a3) blocking the second control section of said control coating preventing said second control section from being irradiated to produce an un-irradiated control coating;

b1) irradiating said first control section of said control coating with said UV irradiation for said preset irradiation time period to produce an irradiated control coating; and

c) obtaining control coating data from said irradiated control coating and said un-irradiated control coating, wherein said control coating data comprise data selected from color data, gloss data, adhesion data, hardness data, chipping data, corrosion data, or a combination thereof.

The target coating and the control coating that have been blocked from being exposed to the UV irradiation can be referred to as an un-irradiated target coating (2b), and un-irradiated control coating (4b), respectively. One example of a blocker (6) can be used to block the UV irradiation.

The color data of the process can be selected from the aforementioned L,a,b color data, L*,a*,b* color data, L,C,h color data, XYZ color data, or a combination thereof.

The UV irradiation can be provided in combination with any of the aforementioned additional testing conditions or a combination thereof.

The preset irradiation time period can be in any of the aforementioned time range. The preset irradiation time period can also be modified. Increased, or decreased as determined necessary by those who design, perform or administer the test.

This disclosure is also directed to a system for testing UV irradiation on at least one target coating. The system can comprise:

i) a testing chamber (7); and

ii) an UV irradiation source (10) that is capable of providing an UV irradiation having one or more UV irradiation wavelengths in a range of from 250 nm to 450 nm and an irradiation power in a range of from 400 VV/m² to 20,000 W/m², said UV irradiation source is configured to provide said irradiation within said testing chamber (7);

wherein said testing chamber comprises one or more testing control devices for providing testing conditions within said testing chamber, said testing conditions are selected from a preset humidity level a preset temperature range, a predetermined salt type or combination, a preset salt level, a preset acid level, a preset alkaline level, ore combination thereof.

The system can further comprise:

iii) a power control device for regulating said irradiation power of said UV irradiation; and

iv) a wavelength control device for regulating said UV irradiation wavelengths.

The power control device can adjust or control UV irradiation power measured at the coating to be tested by adjusting the distance between the UV source (10) and the coatings as indicated by the arrow (20) (FIG. 2), UV reflection assembly such configurations of reflection mirrors, power of the UV source such as the power of the UV lamp or UV LED, or a combination thereof. The power control device can comprise one or more devices, such as one or more mechanical adjustment devices for adjusting positions of the UV lamps in the irradiation chamber, one or more mirrors for delivering UV irradiation, one or more power control units for each of the UV lamps or UV LEDs, or a combination thereof. Any other power control devices that can control the UV irradiation power that are known to or developed by those skilled in the art can be suitable.

The wavelength control device can comprise one or more devices, such as one or more wavelength specific UV filters, one or more UV sources having different wavelengths, or a combination thereof. Any other wavelength control devices that can control the UV irradiation wavelength that known to or developed by those skilled in the art can be suitable.

One or more target coatings (2) or control coatings (4) can be placed in the testing chamber (7). In one example, the testing chamber can be configured to be combined with a conveying belt system (8) so the coatings can be exposed to the UV irradiation from the UV irradiation source (10) while being moved through the testing chamber in one of the directions (9) (FIG. 2A). The UV irradiation time can be controlled by the speed of the conveying belt. In another example, the coatings can be placed stationary in the testing chamber for a pre-set time period (FIG. 2B). In yet another example, the speed of the conveying belt can be varying or stopped so the coatings can be exposed to the UV irradiation at an irradiation time determined necessary by those who design, perform or administer the test.

The system can further comprise:

v) an irradiation blocker that is configured to block at least a section of said target coating preventing said section from being irradiated by said UV irradiation in said testing chamber.

In one example, the irradiation blocker (11) can comprise a blocking cover (12), a base (13), and one or more connection assemblies (14) that can connect the blocking cover (12), and the base (13). The blocking cover and the base can have an adjustable distance (15) in between so a coating with various sizes or thicknesses can be positioned therein. The blacking cover (12) can be used to block the UV irradiation.

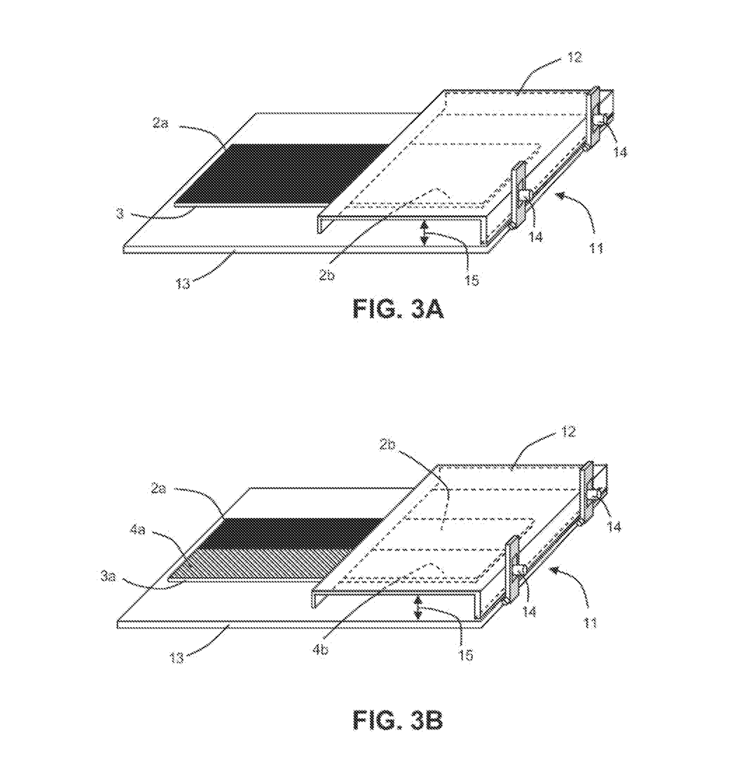

A target coaling over an substrate (3) can be positioned on the irradiation blocker so configured, that one section of the target coating can be exposed to the UV irradiation to produce an irradiated target coating (2a), while another section can be blocked from the UV irradiation to produce an un-irradiated target coating (2b) (FIG. 3A).

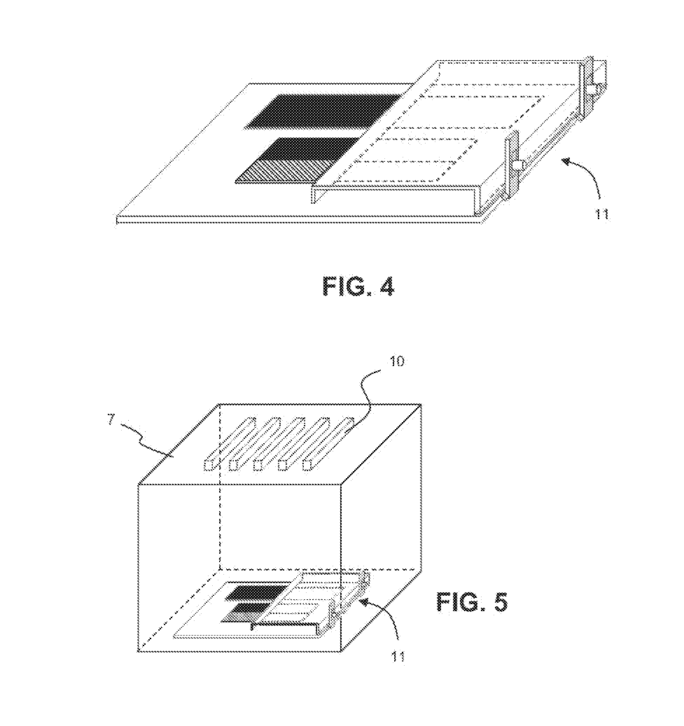

A target coating and a control coating can be positioned in the irradiation blocker so configured that one section of each of the target coating and the control coating can be exposed to the UV irradiation to produce an irradiated target coating (2a) and an irradiated control coating (4a), while another section of each of the coatings can be blocked from the UV irradiation to produce un-irradiated target coating (2b) and un-irradiated control coating (4b) (FIG. 3B). Multiple coatings, such as one or more target coatings and one or more control coatings can be positioned onto the irradiation blocker (FIG. 4) and can be positioned in the testing chamber (FIG. 5).

The testing chamber can comprise one or more testing control devices for providing testing conditions within the testing chamber, wherein the testing conditions can be selected from a preset humidity level, a preset temperature range, a predetermined salt type or combination, a preset salt level, a preset acid level, a preset alkaline level, or a combination thereof. In one example, the humidify level in the testing chamber can be controlled by using water spraying device or a water vapor device. The testing chamber can also be coupled to a humidifier or a dehumidifier for controlling the humidify levels in the chamber. The temperature range can be controlled by a heating or cooling device. The salt type or concentration, acid level, or alkaline level can be controlled by spraying mist having desired salt type and concentrations into the testing chamber.

One advantage of the process and the system is the short testing time. Another advantage of the process and the system is that the coatings can be exposed to ail desired testing conditions such as the temperature range, the humidity level with and without the UV irradiation. The irradiation blocker having the combination of the blocking cover and the base can block the coating from the UV irradiation while permitting the coating to be exposed to other testing conditions.

The system can further comprise a color measurement device, a gloss measurement device, a hardness measurement device, a pH measurement device, a moisture measurement device, a temperature measurement device, a conductance measurement device, an irradiation measurement device, or a combination thereof. Any of the devices known to or developed by those skilled in the art for the desired purposes can be suitable.

What is claimed is:

1. A process for testing UV irradiation on at least one target coating, said process comprising the steps of:
a) providing the target coating;
b) irradiating said target coating with an UV irradiation for a preset irradiation time period to produce an irradiated target coating, said UV irradiation having one or more UV irradiation wavelengths in a range of from 250 nm to 450 nm and an irradiation power in a range of from 400 W/m² to 20,000 W/m² measured at said target coating; and
c) obtaining irradiated target coating data of said irradiated target coating, wherein said irradiated target coating data comprise data selected from color data, gloss date, adhesion data, hardness data, chipping data, corrosion data, or a combination thereof.

2. The process of claim 1 further comprising the steps of:
d) providing at least one control coating; and
e) irradiating said control coating with said UV irradiation to produce an irradiated control coating; and
f) obtaining irradiated control coating data from said irradiated control coating, wherein said irradiated control coating data comprise data selected from color data, gloss data, adhesion data, hardness data, chipping data, corrosion data, or a combination thereof.

3. The process of claim 1, wherein said color data are selected from L,a,b color data, L*,a*,b* color data, L,C,h color data, XYZ color data, or a combination thereof.

4. The process of claim 1, wherein said preset irradiation time period is in a range of from 1 minute to 120 minutes.

5. The process of claim 1, wherein said UV irradiation is provided in combination with additional testing conditions selected from a preset humidity level, a preset temperature range, a predetermined salt type or combination, a preset salt level, a preset acid level, a preset alkaline level, or a combination thereof.

6. The process of claim 1 further comprising the step of obtaining a pre target coating data of said target coating prior to said irradiation, wherein said pre target coating data comprises data selected from color data, gloss data, adhesion data, hardness data, chipping data, corrosion data, or a combination thereof.

7. A process for testing UV irradiation on at least one target coating, said process comprising the steps of:
a) providing the target coating having al least a first section and a second section;
a1) blocking the second section of said target coating preventing said second section from being irradiated to produce an un-irradiated target coating;
b) irradiating said first section of said target coating with an UV irradiation for a preset irradiation time period to produce an irradiated target coating, said UV irradiation having one or more UV irradiation wavelengths in a range of from 250 nm to 460 nm and an irradiation power in a range of from 400 W/m² to 20,000 W/m² measured at said target coating; and
c1) obtaining target coating data from said irradiated target coating and said un-irradiated target coating, wherein said target coating data comprise data selected from color data, gloss data, adhesion data, hardness data, chipping data, corrosion data, or a combination thereof.

8. The process of claim 7 further comprising the steps of:
a2) providing at least one control coating having at least a first control section and a second control section;
a3) blocking me second control section of said control coating preventing said second control section from being irradiated to produce an un-irradiated control coating;
b1) irradiating said first control section of said control coating with said UV irradiation for said preset irradiation time period to produce an irradiated control coating; and
c) obtaining control coating data from said irradiated control coating and said un-irradiated control coating, wherein said control coating data comprise data selected from color data, gloss data, adhesion data, hardness data, chipping data, corrosion data, or a combination thereof.

9. The process of claim 7, wherein said color data comprises L,a,b color data, L*,a*b* color data, L,C,h color data, XYZ color data, or a combination thereof.

10. The process of claim 7, wherein said UV irradiation is provided in combination with additional testing conditions selected from a preset humidity level, a preset temperature range, a predetermined salt type or combination, a preset salt level, a preset acid level, a preset alkaline level, or a combination thereof.

11. The process of claim 7, wherein said preset irradiation time period is in a range of from 1 minute to 120 minutes.

12. The process of claim 7, wherein said UV irradiation is provided in combination with additional testing conditions selected from a preset humidity level, a preset temperature range, a predetermined salt type or combination, a preset salt level, a preset acid level, a preset alkaline level, or a combination thereof.

13. A system for testing UV irradiation on at least one target coating, said system comprising:
i) a testing chamber; and
ii) an UV irradiation source that is capable of providing an UV irradiation having one or more UV irradiation wavelengths in a range of from 250 nm to 450 nm and an irradiation power in a range of from 400 W/m² to 20,000 W/m², said UV irradiation source is configured to provide said irradiation within said testing chamber;
wherein said testing chamber comprises one or more testing control devices for providing testing conditions within said testing chamber, said testing conditions are selected from a preset humidity level, a preset temperature range, a predetermined salt type or combination, a preset salt level, a preset acid level, a preset alkaline level, or a combination thereof.

14. The system of claim 13 further comprising:
iii) a power control device for regulating said irradiation power of said UV irradiation; and
iv) a wavelength control device for regulating said UV irradiation wavelengths.

15. The system of claim 13 further comprising:
v) an irradiation blocker that, is configured to block at least a section of said target coating preventing said section from being irradiated by said UV irradiation in said testing chamber.

16. The system of claim 13 further comprising a color measurement device, a gloss measurement device, a hardness measurement device, a pH measurement device, a moisture measurement device, a temperature measurement device, a conductance measurement device, an irradiation measurement device, or a combination thereof.
